(19) United States
(12) Patent Application Publication
(10) Pub. No.: US 2010/0140996 A1
(43) Pub. Date: Jun. 10, 2010

(54) AUXILIARY SEAT FOR A MOTOR VEHICLE

(75) Inventor: Jens WINTER, Gau-Bischofsheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/631,141

(22) Filed: Dec. 4, 2009

(30) Foreign Application Priority Data
Dec. 5, 2008 (DE) 102008060747.9

(51) Int. Cl. B60N 2/24; B60N 2/30; B60N 2/01; B60N 2/04

(52) U.S. Cl. 297/248

(57) ABSTRACT

For the implementation of an auxiliary seat, which has a material web, which can be unrolled and rolled like a roller blind, made of a tear proof, flexible material, which is fastenable to both vehicle seats between two vehicle seats, which are spaced apart, of a seat row to implement the auxiliary seat, a solution is to be developed, using which the auxiliary seat can be implemented and removed again as needed, requires little storage space, and is to be securely situated in the motor vehicle in its usage position. This is achieved in that the material web is fastened on a roll at each of its opposing longitudinal ends so it can be rolled and both rolls have a fastener on their longitudinal ends, which is fastenable to one of the vehicle seats in each case to implement the auxiliary seat.

### CROSS-REFERENCE TO RELATED APPLICATION

This application claims priority to German Patent Application No. 102008060747.9, filed Dec. 5, 2008, which is incorporated herein by reference in its entirety.

### TECHNICAL FIELD

The invention relates to an auxiliary seat, which has a material web made of a tear proof, flexible material, which can be unrolled and rolled like a roller blind, which is fastenable to both seats between two vehicle seats of a seat row, which are spaced apart, to implement the auxiliary seat, and an auxiliary seat configuration, comprising two vehicle seats of a seat row of a motor vehicle, which are situated spaced apart from one another, and an auxiliary seat situated between them made of a material web which can be unrolled like a roller blind, which is removably fastened between the vehicle seats and implements a seat area having backrest in this installed position.

### BACKGROUND

All seat spaces are occupied during less than one percent of all trips of a passenger automobile. In particular, in passenger automobiles having a seat row comprising three seat spaces, the middle seat thereof is occupied extremely rarely. This means that a part of the vehicle seats is useless during most trips, which is true in particular for the middle seat of the rear seat row. The space occupied by the unneeded vehicle seats results in comfort losses for the used vehicle seats. For example, the implementation of the three-seat rear seat row has the result that comfort losses must be accepted for the outer vehicle seats in comparison to the implementation of a seat row having two vehicle seats implemented as single seats.

DE 31 02 881 A1 discloses an emergency seat configuration for a motor vehicle, in which an emergency seat, which essentially comprises a tear proof, flexible, and collapsible material web, can be implemented in that the material web is stretched to implement an emergency seat with the aid of hooks anchored in a vehicle floor to implement the seat surface and a hook engaging on a transversely stretched cable in the motor vehicle to implement the backrest. When not in use, the material web is rolled up or collapsed and stowed at a location in the motor vehicle provided for this purpose. The emergency seat is situated and implemented independently of vehicle seat rows in the motor vehicle, special anchoring points having to be provided in the vehicle floor for the fastening.

Furthermore, DE 1 685 303 U describes an intermediate seat for omnibuses, which can be situated on two vehicle seats of a vehicle row bridging two seats which are spaced apart. A material web which can be rolled up in the form of a roller blind is provided, which is provided on one side with a tube having two forks. The intermediate seat is fastenable using the forks by mounting on receptacle elements of the vehicle seats which form gripping rods, so that the material web can then be unrolled and implements a seat surface having backrest bridging the gap between the two vehicle seats which are spaced apart. The material web is situated resting loosely in its edge areas on the spaced apart vehicle seats for this purpose and the seat surface is solely implemented by steel bands incorporated in the material. In this way, however, a loss of comfort is caused in that the seat surface can move relative to the adjacent vehicle seats when cornering, for example.

In order to be able to implement auxiliary seats which correspond to the current comfort requirements, the requirement exists that such a seat only be present when it is also actually needed. In addition, the requirement exists that such a seat is to be designed so that the vehicle seats also situated in the motor vehicle have an enlarged installation space and thus the vehicle occupant using such a vehicle seat can be offered an improved feeling of room and improved comfort.

It is at least one object of the invention to provide an auxiliary seat of the type cited at the beginning which can be implemented and removed on demand, requires little storage space, and is to be situated securely in the motor vehicle in its usage position. In addition, other objects, desirable features, and characteristics will become apparent from the subsequent detailed description, and the appended claims, taken in conjunction with the accompanying drawings and this background.

### SUMMARY

The at least one object, other objects, desirable features, and characteristics, are achieved according to embodiments of the invention for an auxiliary seat in that the material web is fastened so it can be rolled up on a roll at each of its opposing longitudinal ends and both rolls have a fastener on each of their longitudinal ends, which are each fastenable to one of the vehicle seats to implement the auxiliary seat.

The at least one object, other objects, desirable features, and characteristics, are achieved according to embodiments of the invention for an auxiliary seat configuration in that the vehicle seats are situated so they can be moved apart and the material web is situated having each of its longitudinal ends on a roll so it can be rolled up, the rolls each having fasteners which are detachably engaged with receptacle elements implemented on the vehicle seats.

The auxiliary seat and the auxiliary seat configuration allow vehicle seats implemented as single seats to be situated adjacent to one another in a seat row and thus the comfort familiar from single seats to be offered. As long as an auxiliary seat is not needed, the intermediate space located between the vehicle seats can also be used as a storage space. If the auxiliary seat is to be implemented, the auxiliary seat, which is preferably stowed in a storage space of the motor vehicle, is taken from the storage space, the fasteners of one roll are mounted in the upper receptacle elements implemented on the associated vehicle seat and the material web is unrolled. The fasteners of the other roll are subsequently fastened on the other lower receptacle elements implemented on the vehicle seat, so that in this way the auxiliary seat is stretched out. The auxiliary seat is securely fastened between the two seats, because the rolls are each fastened at there two longitudinal ends using one fastener in each case in the receptacle element situated on the particular adjoining vehicle seat, in particular engaging in the receptacle elements. The fasteners and the receptacle elements are detachably connected to one another, in order to be able to remove the auxiliary seat readily again.

The advantages of the auxiliary seat and the auxiliary seat configuration are that through the separate configuration of the vehicle seats, extraordinary comfort with great elbow freedom is provided toward the doors of the motor vehicle and between the vehicle seats. In addition, because of the positioning of the vehicle seats further inward, an occupant has significantly improved head freedom to the roof column and to the C column relative to a three-seat configuration. In addition, the flexible two-seat configuration offers the advantage relative to the three-seat configuration of vehicle seats that the installation space located between the vehicle seats provides possibilities for an increased number of compartment and storage capabilities having an enlarged volume. The intermediate space can also be used as a pass-through capability to the trunk. It is nonetheless possible to provide a third seat, namely the auxiliary seat, for the seat row on demand and to carry five occupants in a passenger automobile of typical size. In order to achieve simple use and installation of the auxiliary seat implemented as a middle seat, all relevant elements, i.e., the fasteners and the dimensions of the rolls and the receptacle elements, are each implemented identically.

The fasteners for implementing the auxiliary seat advantageously work together with one receptacle element situated on one side of the vehicle seats in each case. Preferably, one receptacle element is implemented laterally to the backrest and one receptacle element is implemented laterally to the seat surface on a vehicle seat in each case. In this way, a fastening capability is provided for the fasteners of the auxiliary seat which is located precisely in the seat and backrest plane implemented by the vehicle seats, in particular single vehicle seats.

To implement an exact transition from the seat surface to the backrest in the auxiliary seat, in one embodiment, a clip which implements the valley in the transition from the auxiliary seat surface to the auxiliary seat backrest in the installed position of the auxiliary seat is situated between the two rolls, in particular so it is displaceable on the material web. The clip is expediently situated on or close to the vehicle body floor to implement the auxiliary seat. A device on the vehicle floor side suggests itself for this purpose, on which the clip can be fastened in the installed position of the auxiliary seat.

In order to cause automatic rolling up of the material web when the auxiliary seat is removed again, at least one of the rolls is expediently equipped with a spring like a roller blind roll, which exerts a rolling force on the material web.

In order that particularly secure fastening of the auxiliary seat between the vehicle seats is achieved, the receptacle elements are advantageously integrated and/or anchored in the seat structure of the vehicle seats. Fastening points are thus provided, which give the vehicle seat sufficient security in the motor vehicle. The fastener is expediently a locking pin.

The rolls which carry the material web are preferably metal rolls. The longitudinal ends of the material web are advantageously fastened to the particular associated roll by being sewn around it.

Because the auxiliary seat may be retracted to a size which requires relatively little storage space when not in use as a result of its implementation like a roller blind, it is possible to stow it in a storage compartment in front of or below a vehicle seat when not in use.

In order to simplify the installation of the auxiliary seat between the vehicle seats, both rolls are implemented having equal dimensions. It thus does not play a role which roll is installed first and it does not play a role whether a roll is mounted in the upper or the lower receptacle elements.

The auxiliary seat configuration is distinguished in one embodiment in that the vehicle seats are single seats which can be moved apart in the vehicle transverse direction. This allows the desired comfort to be provided for those trips in which an auxiliary seat is not needed or desired.

It is obvious that the above-mentioned features and the features to be explained hereafter are usable not only in the particular disclosed combination, but rather also in other combinations. The scope of the present invention is only defined by the claims.

### BRIEF DESCRIPTION OF THE DRAWINGS

The present invention will hereinafter be described in conjunction with the following drawing figures, wherein like numerals denote like elements, and:

FIG. 1 shows a schematic illustration of an auxiliary seat according to the invention;

FIG. 2 shows a roll of the auxiliary seat according to FIG. 1; and

FIG. 3a through FIG. 3c show the installation procedure of the auxiliary seat from FIG. 1.

### DETAILED DESCRIPTION

The following detailed description is merely exemplary in nature and is not intended to limit application and uses. Furthermore, there is no intention to be bound by any theory presented in the preceding background or summary or the following detailed description.

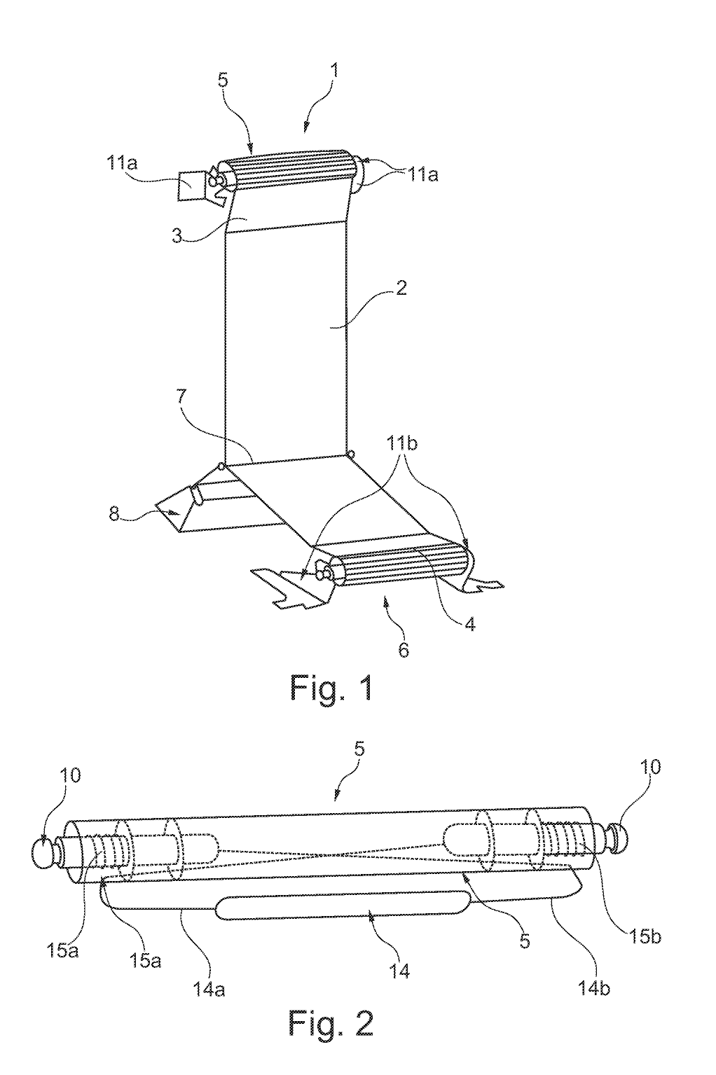

The auxiliary seat 1 according to FIG. 1 is located in its installed configuration, which is implemented by unrolling the material web 2. The material web is a tear proof, flexible material which can be rolled up, and which is fastened using its opposing longitudinal ends 3, 4 to one roll 5, 6 in each case. This fastening is performed by sewing the material web 2 around the particular roll 5, 6, for example. A clip 7 is situated so it is displaceable on the material web 2 between the rolls 5, 6. In the installed position of the auxiliary seat 1, the clip 7 is fastened with the aid of a fitting element 8 on a vehicle body floor 9.

The rolls 5, 6, which comprise metal, each have a fastener 10 in the form of a locking pin on each of their longitudinal ends. The fasteners 10 engage in the installed position of the auxiliary seat 1 according to FIG. 1 in a particular associated upper or lower receptacle element 11a, 11b, which is fastened to the seat structure of one vehicle seat 12, 13 in each case. The receptacle elements 11a, 11b are situated on lateral surfaces of the vehicle seats 12, 13 facing toward one another, the upper receptacle elements 11a being situated in the upper end area of the backrest of the vehicle seats 12, 13, which are implemented as single seats, and the lower receptacle elements 11b being situated on the front end area of the seat surfaces of the vehicle seat 12, 13.

The roll 5 according to FIG. 2 is equipped with a handle 14, whose end areas are each connected via clip-shaped elements 14a, 14b, which cross one another, to one of the fasteners 10. The force of a spring 15a, 15b is applied to each of the fasteners 10 within the roll 5, the spring force driving the end areas of the fasteners 10 on the roll outer side outward. By pulling on the handle 14, a user can apply a traction force acting against the force of the springs 15a, 15b and thus pull the locking pin, which is situated so it is movable in the roll 5, in the direction toward the interior of the roll 5. It is thus possible to disengage the fasteners 10 from the receptacle elements 11a or 11b and in this way to detach the rolls 5, 6 from the receptacle elements 11a, 11b when the auxiliary seat is uninstalled. Although only one roll 5 is shown in FIG. 2, both rolls 5, 6 are constructed identically.

The rolls 5, 6 may be equipped with a further spring situated in the interior (not shown) as known from typical roller blinds, which causes the material web to roll up automatically, i.e., exerts the force required for a rolling movement on the material web.

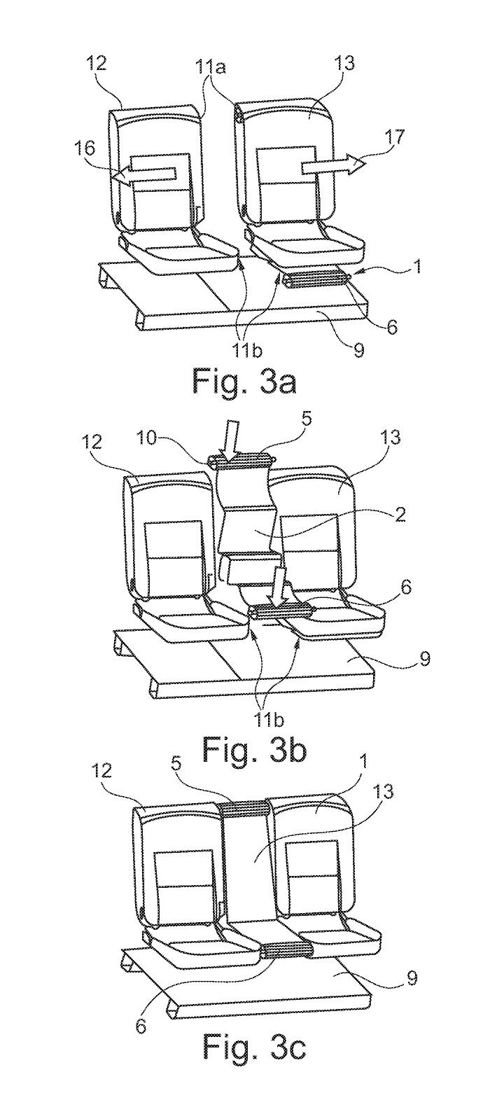

According to FIG. 3a, two vehicle seats 12, 13 situated on the vehicle body floor 9 are implemented as single seats, an intermediate space being implemented in each case between the vehicle seats 12, 13 and toward the vehicle outer side, which does not have the width necessary for implementing the auxiliary seat. To implement the auxiliary seat, the vehicle seats 12, 13 are pushed apart in the direction of the arrows 16, 17. For this purpose, corresponding rails are provided in the vehicle body floor 9. The auxiliary seat 1 is still located at this point in time in its rolled-up form in a storage compartment implemented below the vehicle seat 13. After the vehicle seats 12, 13 are pushed apart to implement an intermediate space corresponding to the length of the rolls 5, 6, the rolls 5, 6 under the vehicle seat 13 are pulled out and, as is obvious from FIG. 3b, mounted using their fasteners 10 in the upper receptacle elements 11a and the lower receptacle elements 11b. The clip 7 is also fastened on the vehicle body floor side, so that the finished installed position of the auxiliary seat 1 shown in FIG. 3c results.

In the exemplary embodiment shown, the auxiliary seat 1 is implemented as the middle seat of a second seat row of a passenger automobile. In general, the auxiliary seat configuration may be transferred to any seat row of a motor vehicle, in particular passenger automobiles. The two vehicle seats 12, 13 form outer seat spaces of such a seat row and have freestanding backrests. In addition, the vehicle seats 12, 13 are adjustable in the vehicle width via rails. Of course, adjustment capabilities may also be provided in the vehicle longitudinal direction. The particular receptacle devices, which receive the fasteners 10 of the rolls 5, 6, which are implemented in the form of securing and locking pins, by latching and fixing, are located on the inner side of the seat cushions and the backrests of the vehicle seats 12, 13.

The intermediate space existing between the vehicle seats 12, 13 without the auxiliary seat 1 can be used for the storage of objects or as a passage to the trunk. A storage compartment for storing objects can also be provided between the vehicle seats 12, 13. Because of their inwardly shifted position, the vehicle seats 12, 13 offer an enlarged space to the exterior vehicle doors relative to a three-seat seat row, which provides the passengers on these outer vehicle seats 12, 13 with additional elbow freedom and head freedom to the C column.

Because the rolls 5, 6 of the auxiliary seat 1 are implemented identically, the rolls 5, 6 may be positioned arbitrarily between the vehicle seats 12, 13 and locked in the receptacle elements 11a, 11b. Because, in addition, the clip 7 implementing the transition between seat surface and backrest in the auxiliary seat 1 is situated so it is freely displaceable on the material web 2, this also allows the free configuration of the rolls 5, 6, because no consideration must be taken of the differing length implementation of backrest and seat surface, but rather the auxiliary seat 1 adapts itself to the particular conditions. The installation steps comprise in sequence: firstly the mounting of one of the rolls 5, 6 in the upper or lower receptacle elements 11a, 11b, followed by the fastening of the clip 7 on the fitting element 8 on the vehicle body floor side, and the subsequent fastening of the second roll 5, 6 on the remaining receptacle elements 11a, 11b.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An auxiliary seat, comprising:
a material web that can be unrolled and rolled like a roller blind and made of a tear proof, flexible material that is fastenable between two vehicle seats that are spaced apart, wherein the material web is fastened on each of a first longitudinal end opposing a second longitudinal end;
a first roll adapted to receive the material web;
a second roll adapted to receive the material web;
a first fastener for the first longitudinal end of the first roll and a second fastener for the second longitudinal end of the second roll, the first fastener and the second fastener are adapted to fasten to one of the two vehicle seats.

2. The auxiliary seat according to claim 1, wherein the first fastener and the second fastener are adapted to cooperate with a first receptacle element and a second receptacle element situated on a side of the two vehicle seats.

3. The auxiliary seat according to claim 2, wherein the first receptacle element is situated laterally of a backrest and the second receptacle element is situated laterally of a seat surface of one of the two vehicle seats.

4. The auxiliary seat according to claim 1, further comprising a clip situated between the first roll and the second roll to implement a valley in a transition from a seat surface to a backrest of the auxiliary seat in an installed position of the auxiliary seat.

5. The auxiliary seat according to claim 4, wherein the clip for implementing the auxiliary seat is situated in at least relative proximity to a vehicle body floor.

6. The auxiliary seat according to claim 1, wherein at least one of the first roll and the second roll is implemented with a spring that exerts a rolling force on the material web.

7. The auxiliary seat according to one of claim 2, wherein the first receptacle element and the second receptacle element are integrated in a seat structure of the two vehicle seats.

8. The auxiliary seat according to claim 1, wherein the first fastener is a locking pin.

9. The auxiliary seat according to claim 1, wherein at least one of the first roll and the second roll is a metal roll.

10. The auxiliary seat according to claim 1, wherein the first longitudinal end of the material web is sewn to the first roll and the second longitudinal end of the material web is sewn to the second roll.

11. The auxiliary seat according to claim 1, wherein the auxiliary seat is adapted for storage in a tray.

12. The auxiliary seat according to claim 1, wherein the first roll and the second roll have substantially similar dimensions . . . .

13. A seat configuration, comprising:
a first seat;
a second seat spaced apart from the first seat; and
an auxiliary seat situated between the first seat and the second seat, the auxiliary seat comprising:
a material web that can be unrolled and rolled like a roller blind and made of a tear proof, flexible material that is fastenable between two vehicle seats that are spaced apart, wherein the material web is fastened on each of a first longitudinal end opposing a second longitudinal end;
a first roll adapted to receive the material web;
a second roll adapted to receive the material web;
a first fastener for the first longitudinal end of the first roll and a second fastener for the second longitudinal end of the second roll, the first fastener and the second fastener are adapted to fasten to one of the first seat and the second seat.

14. The seat configuration according to claim 13, wherein the first seat and the second seat are single seats that can be moved apart in a transverse direction.

15. The seat configuration according to claim 14, wherein the first fastener and the second fastener are adapted to cooperate with a first receptacle element and a second receptacle element situated on a side of the two vehicle seats.

16. The seat configuration according to claim 15, wherein the first receptacle element is situated laterally of a backrest and the second receptacle element is situated laterally of a seat surface of one of the two vehicle seats.

17. The seat configuration according to claim 16, further comprising a clip situated between the first roll and the second roll to implement a valley in a transition from the seat surface to the backrest of the auxiliary seat in an installed position of the auxiliary seat.

18. The seat configuration according to claim 17, wherein the clip for implementing the auxiliary seat is situated in at least relative proximity to a vehicle body floor.

19. The seat configuration according to claim 14, wherein at least one of the first roll and the second roll is implemented with a spring that exerts a rolling force on the material web.

20. The seat configuration according to one of claim 15, wherein the first receptacle element and the second receptacle element are integrated in a seat structure of the two vehicle seats.
